(19) United States
(12) Patent Application Publication
(10) Pub. No.: US 2009/0211392 A1
(43) Pub. Date: Aug. 27, 2009

(54) BOWDEN CABLE AND CASING THEREFORE

(75) Inventors: Thorsten HAHN, Gau-Odernheim (DE); Axel GEIBERGER, Mainz (DE)

Correspondence Address: INGRASSIA FISHER & LORENZ, P.C. (GME), 7010 E. COCHISE ROAD, SCOTTSDALE, AZ, 85253, US

(73) Assignee: GM GLOBAL TECHNOLOGY OPERATIONS, INC., Detroit, MI (US)

(21) Appl. No.: 12/390,023

(22) Filed: Feb. 20, 2009

(30) Foreign Application Priority Data
Feb. 20, 2008 (EP) 08003096.8-2424

(51) Int. Cl. F16C 1/26; F16C 1/10

(52) U.S. Cl. 74/502.5

(57) ABSTRACT

A Bowden cable is provided that includes, but not limited to, a casing and a wire extending in a cavity of the casing. Points of contact between the wire and the casing are unevenly distributed on the circumference of the wire in each cross section. A clearance extends helicoidally along the wire. The helicoidal clearance has a pitch (L) at least equal to twice the diameter (D) of the wire. In each cross section the clearance extends around at least half of the circumference of the wire.

### CROSS-REFERENCE TO RELATED APPLICATION

This application claims priority to European Patent Application No. 08003096.8-2424, filed Feb. 20, 2008, which is incorporated herein by reference in its entirety.

### TECHNICAL FIELD

The present invention relates to a Bowden cable and to a Bowden cable casing that can be used for transmitting pulling and/or pushing forces (e.g., for driving shifting movements in a transmission of a motor vehicle).

### BACKGROUND

A Bowden cable is generally known to comprise a tubular casing, which is usually flexible, but resistant against compression in its longitudinal direction, and a wire which is longitudinally displaceable in a cavity of the casing. In order to avoid excessive friction between the wire and the casing, the diameter of the wire is usually slightly less than that of the cavity. Due to this difference in diameter, the wire is able to vibrate within the cavity and, if the amplitude of the vibration becomes excessive, it will hit against the casing, causing a rattling noise.

Cable rattling might be prevented if the cable fitted tightly inside the casing. This approach is followed in JP 2000 314 416A. This document discloses a casing for a push-pull control cable having a hexagonal cavity. Dimension variations of the cavity and the cable slidably received in it, which may be due to manufacturing tolerances or to different thermal expansion coefficients of cable and casing, can be accommodated by slightly distorting the cross section of the casing. Since the casing must not be too soft in order to be compression resistant, it is still difficult to ensure that friction between cable and casing does not become excessive.

DE 30 21 533 A1 suggests prevention of vibrations of the inner wire in a Bowden cable by providing a flexible plastic hose in a clearance between the wire and the casing. The plastic hose has a plurality of helicoidal webs at its inner and outer surfaces and can be made flexible enough to accommodate variations of the diameters of the wire and the cavity by distorting its cross section. However, the plastic hose makes this Bowden cable rather expensive and difficult to assemble.

U.S. Pat. No. 3,214,995 discloses a push-pull cable with a plastic-lined casing, in which the casing is formed by helically wrapping a flat metal wire around an extruded plastic tubing. The pressure of the wrapping wire causes helicoidal webs to form at an inner side of the tubing, which are in contact with the push-pull wire extending straight through the tubing. Friction between the helical webs and the push-pull wire depends critically on the tension of the wire wrapped around the tubing. The tension of the wrapping wire are controlled very carefully in order to ensure that webs become prominent enough to prevent the push-pull wire from vibrating and that the friction between the push-pull wire and the tubing does not become excessive. Controlling the tension is the more difficult the broader the wrapping wire is difficult. Therefore the pitch of the wrapping wire is not more than approximately the diameter of the push-pull wire.

In view of the foregoing, at least one object of the present invention is to provide a Bowden cable and a casing therefore in which vibrations of the push-pull wire are reliably prevented without the risk of excessive friction. In addition, other objects, desirable features, and characteristics will become apparent from the subsequent summary and detailed description, and the appended claims, taken in conjunction with the accompanying drawings and this background.

### SUMMARY

The at least one object, other objects, desirable features and characteristics, are achieved, on the one hand, by a Bowden cable comprising a casing and a wire extending in a cavity of said casing, points of contact between the wire and the casing being unevenly distributed on the circumference of the wire in each cross section, and a clearance extending helicoidally along the wire, in which the helicoidal clearance has a pitch at least equal to twice the diameter of the wire and in each cross section the clearance extends around at least half of the circumference of the wire. Since the pitch of the clearing is substantially longer here than in U.S. Pat. No. 3,214,995, the wire can yield easily to a pressure at a point of contact so that although the cross section of the cavity and/or the diameter of the wire may vary along the Bowden cable due to manufacturing tolerances, there is no risk of the friction between wire and casing becoming excessive.

Preferably, the points of contact are located on a cylinder surface, the diameter of which is less than the diameter of the wire. Due to this design, the wire cannot go straight through the casing, but is urged into a slightly tortuous shape by the casing.

The Bowden cable is rather easy to manufacture if the clearance extends helicoidally along the wire. In that case the entire casing or at least an inner liner thereof may e.g. be formed by extrusion.

In order to avoid excessive bending stress of the wire, the helicoidal clearance preferably has a pitch at least equal to five times the diameter of the wire. In order to effectively prevent the wire from vibrating, the pitch should not be more than approximately 50 times the diameter of the wire.

The points of contact may define at least one helicoidal curve. Such a curve may be formed by at least one helicoidal web formed at an inner surface of the casing.

In order to stabilize the position of the wire inside the casing, it is preferable that there should be at least two helicoidal webs. Preferably these are located with respect to each other at an angle of more than about 60 degrees and less than about 180 degrees.

If the wire is conventionally formed by twisting a plurality of wire strands, the direction of twist of the wire should opposite to that of the web, in order to avoid the wire from rotating when it is displaced in the casing.

On the other hand, the object, other objects, desirable features, and characteristics of the invention are achieved by a casing for a Bowden cable having a central cavity of non-circular cross section, the shape of which cross section rotates alongside the casing, and the period of the rotation is at least equal to twice a transversal dimension of the central cavity. Such a casing may comprise a hollow cylindrical shell and at least one web extending helicoidally along an inner surface of said shell. There may be a single web, or a maybe a plurality of webs, which are unevenly spaced, at the inner surface of the shell.

### BRIEF DESCRIPTION OF THE DRAWINGS

The present invention will hereinafter be described in conjunction with the following drawing figures, wherein like numerals denote like elements, and

FIG. 1 is a perspective view of a fragment of a Bowden cable casing according to an embodiment of the present invention;

FIG. 2 is a longitudinal section of the casing of FIG. 1 and of a wire extending along the cavity of the casing;

FIG. 3 is a cross section of the Bowden cable taken along plane III/III of FIG. 2;

FIG. 4 is a cross section analogous to FIG. 3 of a Bowden cable according to a second embodiment of the invention; and

FIG. 5 is a cross section analogous to FIG. 3 of a Bowden cable according to a third embodiment of the invention.

### DETAILED DESCRIPTION

The following detailed description is merely exemplary in nature and is not intended to limit application and uses. Furthermore, there is no intention to be bound by any theory presented in the preceding background or summary or the following detailed description.

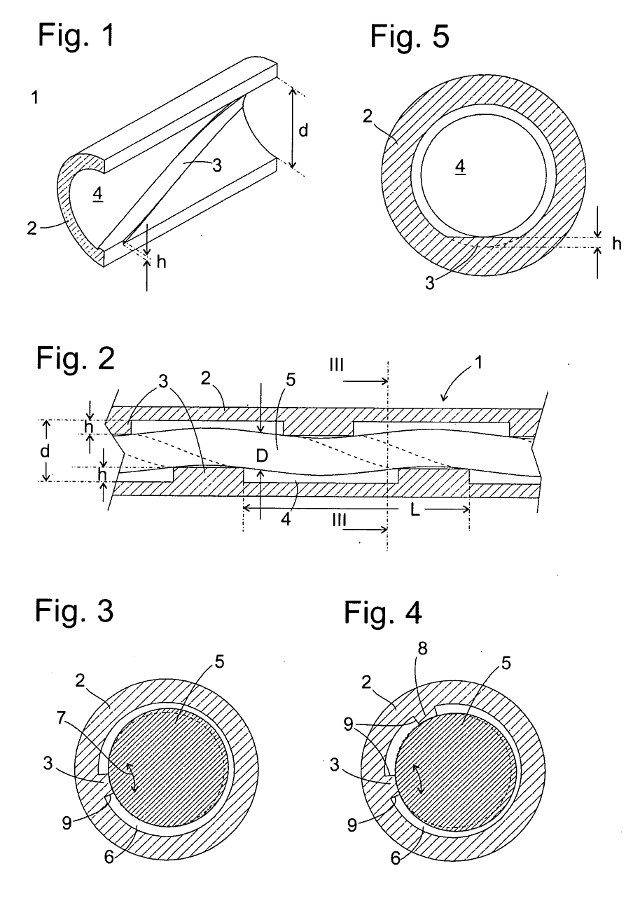

FIG. 1 is a perspective view of a fragment of a casing 1 for a Bowden cable according to a first embodiment of the invention. The casing 1 comprises a hollow cylindrical shell 2, half of which is shown in FIG. 1, and a web 3 of a substantially rectangular or trapezoidal cross section extending helicoidally along an inner surface of shell 2. In the casing portion shown in FIG. 1, the web 3 extends around approximately a quarter of the circumference of the inner cavity 4 of casing 1 so that the pitch D (see FIG. 2) of the web 3 can be estimated to be approximately 10 times the diameter d of cavity 4. The dimension of the web 3 in the radial direction of shell 2 (i.e., the height h of the web 3) is a small fraction of diameter d (e.g., less than d/10).

It is easily conceivable that the summit of the web 3 defines an imaginary cylindrical surface having a diameter of (d−2h) and extending coaxially with respect to the inner and outer surfaces of shell 2.

FIG. 2 is a longitudinal section of a portion of casing 1 showing a push-pull wire 5 extending within the cavity 4. The wire 5 has a circular cross section and a diameter D between d and d−2h. This is why the wire 5 cannot go straight along cavity 4, but is slightly bent into a helicoidal configuration.

As shown in the cross section of FIG. 3, the wire 5 is not squeezed in the casing 1. There is a clearance 6 extending all around the wire 5, from one side of web 3 to the other. Therefore, the cross section of the casing is not distorted by the wire 5, and the pressure ramming between the summit of web 3 is due exclusively to elastic bending of wire 5 and/or casing 1. The pressure between web 3 and wire 5 does not depend critically on dimensional variations of the casing 1 or the wire 5 so that the friction occurring between casing and wire if the wire 5 is displaced is closely similar for Bowden wires manufactured in a same series, and is practically not influenced by possibly different thermal expansion characteristics of casing 1 and wire 5.

In the cross section of FIG. 3, the wire 5 is supported at a single region of its circumference by the one web 3. If the wire 5 is very flexible, and pitch L of web 3 is long, there is a possibility of the wire 5 rocking around a fulcrum formed by web 3, as suggested by double-pointed arrow 7 in FIG. 3.

This rocking motion is excluded in a second embodiment of the Bowden wire, shown in cross section in FIG. 4. According to this embodiment, the casing 1 comprises two helicoidal webs 3, 8, both of which extend parallel to each other along the inner surface of shell 2 and have their respective summits in contact with wire 5. Thus the wire 5 is supported at two locations in each cross section. Also in this embodiment there is a clearance 6 extending around more than half of the circumference of the wire 5, by which variations of the transversal dimensions of casing 1 and wire 5 can be compensated.

It is easily seen that more webs might be provided without substantially modifying the effect of the embodiments of the invention, provided that a clearance 6 spanning at least half of the circumference of the wire 5 is left between two of said webs.

It is readily apparent that the steep sides 9 of the webs 3, 8 shown in FIG. 3 and FIG. 4 are not relevant for the effect of the embodiments of the invention, and that the webs 8 might have practically any cross section, as long as there is the above-mentioned imaginary cylindrical contact surface for the wire 5 having a diameter smaller than D. For example, FIG. 5 shows a variant of the embodiment of FIG. 3, in which the web 3 is so broad that its sides vanish completely.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A Bowden cable, comprising:
a casing having a cavity; and
a wire extending in the cavity of said casing,
wherein points of contact between the wire and the casing unevenly distributed on a circumference of the wire in each cross section and a clearance extending helicoidally along the wire,
wherein a helicoidal clearance has a pitch at least equal to twice a diameter (D) of the wire and that in each cross section the helicoidal clearance extends around at least half of the circumference of the wire.

2. The Bowden cable of claim 1, wherein the points of contact are located on a cylinder surface having a second diameter (d−2h) of which is less than the diameter (D) of the wire.

3. The Bowden cable of claim 1, wherein the helicoidal clearance has the pitch of at least five times the diameter (D) of the wire.

4. The Bowden cable of claim 1, wherein the helicoidal clearance has the pitch of at most fifty times the diameter (D) of the wire.

5. The Bowden cable of claim 1, wherein the points of contact define at least one helicoidal curve.

6. The Bowden cable of claim 1, wherein the points of contacts are located on at least one helicoidal web formed at an inner surface of the casing.

7. The Bowden cable of claim 1, wherein at least two helicoidal webs are located at an angle of more than about 60° and less than about 180° with respect to each other.

8. The Bowden cable of claim 6, wherein the wire is formed by twisting a plurality of wire strands, a direction of twist of the wire being opposite to that of the at least one helicoidal web.

9. The Bowden cable of claim 1, wherein at least one of the casing or an inner liner of the casing is extrusion-molded.

10. A casing for a Bowden cable, comprising:
a central cavity; and
a non-circular cross section of the central cavity having a shape of which a cross section rotates along said casing,
wherein a pitch of a rotation of the cross section along said casing is at least equal to twice a transversal dimension of the central cavity.

11. The casing of claim 10, further comprising:
a hollow cylindrical shell; and
at least one web extending helicoidally along an inner surface of said hollow cylindrical shell.

12. The casing of claim 11, wherein the casing has a single helicoidal web.

13. The casing of claim 10, wherein the casing has a plurality of helicoidal webs and the plurality of helicoidal webs are unevenly spaced.
